(19) United States
(12) Patent Application Publication
(10) Pub. No.: US 2024/0208523 A1
(43) Pub. Date: Jun. 27, 2024

(54) DRIVING ASSISTANCE DEVICE AND DRIVING ASSISTANCE METHOD

(71) Applicant: TOYOTA JIDOSHA KABUSHIKI KAISHA, Aichi (JP)

(72) Inventors: Yuki HATSUDE, Toyota-shi (JP); Hiroki SHIMAZU, Toyota-shi (JP)

(21) Appl. No.: 18/391,668

(22) Filed: Dec. 21, 2023

(30) Foreign Application Priority Data
Dec. 23, 2022 (JP) 2022-206593

(51) Int. Cl. B60W 50/14; B60R 1/12; B60W 50/00; B60W 50/10

(52) U.S. Cl. CPC B60W 50/14; B60R 1/1207; B60W 50/0097; B60W 50/10; B60W 2050/143; B60W 2554/4041; B60W 2554/4045

(57) ABSTRACT

To effectively suppress an unnecessary alarm, provided is A driving assistance device comprising a processor. The processor is configured to predicting whether an approaching target enters a specific region after a predetermined time has elapsed, when detecting the approaching target in a region on a front side of the vehicle on a side where the right or left side of the turn of the vehicle; predicting a moving state amount as a predicted moving state amount when the approaching target enters the specific region; acquiring an actual movement state amount of an entry target as an actual movement state amount, when detecting the entry target; and determining whether or not the alarm for the entry target as an object target is necessary on the basis of the predicted moving state amount and the actual moving state amount.

### CROSS-REFERENCE TO RELATED APPLICATION

This application claims priority to Japanese Patent Application No. JP2022-206593 filed on Dec. 23, 2022, the content of which is hereby incorporated by reference in its entirety into this application.

### BACKGROUND OF THE INVENTION

### 1. Field of the Invention

The present disclosure relates to a driving assistance device and a driving assistance method, and relates to a driving assistance technique for excuting an alarm when an object that may be dragged in a right turning or left turning of a vehicle is detected.

### 2. Description of the Related Art

For example, Japanese Patent Application Laid-Open (kokai) No. 2017-224164 discloses a driving assistance device such as an alarm when a distance between a two-wheeled vehicle behind a own vehicle and an intersection falls below a predetermined threshold value when the vehicle starts traveling for a left turning from a state where own vehicle is stopped at the intersection.

When an own vehicle detects an object in an alarm region on an inner side of the turn of turning of the own vehicle, for example, when turning right or turning left at the intersection or the like, it is possible to prevent the object from being dragged by executing an alarm to alert the drivers. In such an alarm system, it is assumed that a moving object such as a pedestrian approaching the own vehicle that is going to turning right or left at the intersection or the like from a direction opposite to the traveling direction of the own vehicle passes in front of the own vehicle and enters the alarm region.

The moving objects approaching the own vehicle from the opposite direction are viewed by the drivers as they pass in front of the own vehicle, and after passing in front of the own vehicle they move away from the own vehicle. Therefore, even if the own vehicle starts turning after passing through the moving object due to a right or left turn, the moving object is unlikely to be dragged in the own vehicle. When such the moving object with the low risk of accident is detected in the alarm region by the system, an alarm is given, which gives troublesomeness to the driver.

### SUMMARY OF THE INVENTION

The present disclosure has been made in order to solve the above described problems, and an object thereof is to effectively suppress an unnecessary alarm.

According to the present disclosure, there is provided a driving assistance device for executing an alarm to a driver of a vehicle when a target object is present in a specific region including at least a region on a rear side of the vehicle on a side where the right or left side of the turn of the vehicle when the vehicle turning right or left. The driving assistance device comprising a processor, wherein the processor is configured to execute predicting whether an approaching target enters the specific region after a predetermined time has elapsed on the basis of a moving state amount including at least a moving direction and a moving speed of the approaching target, when detecting the intention of the right or left turning of the driver and when detecting the approaching target in a region on a front side of the vehicle on a side where the right or left side of the turn of the vehicle; predicting, when predicting that the approaching target enters the specific region, a moving state amount as a predicted moving state amount when the approaching target enters the specific region; acquiring an actual movement state amount of an entry target as an actual movement state amount, when detecting the entry target that has entered the specific region; and determining whether or not the alarm for the entry target as an object target is necessary on the basis of the predicted moving state amount and the actual moving state amount.

### BRIEF DESCRIPTION OF THE DRAWINGS

FIG. 1 is a schematic diagram showing a hardware configuration of a vehicle according to the present embodiment.

FIG. 2 is a schematic diagram showing a software configuration of a control device to the present embodiment.

FIG. 3 is a schematic diagram for explaining the drag-in alarm control.

FIG. 4A is a schematic diagram for explaining a flow of the drag-in alarm control.

FIG. 4B is a schematic diagram for explaining a flow of the drag-in alarm control.

FIG. 4C is a schematic diagram for explaining a flow of the drag-in alarm control.

FIG. 5 is a flowchart for explaining a routine of the drag-in alarm control processing.

FIG. 6 is a flowchart for explaining a routine of the alarm suppression control processing.

### DESCRIPTION OF THE EMBODIMENTS

Description is now given of a driving assistance device and a driving assistance method according to at least one embodiment of the present disclosure with reference to the drawings.

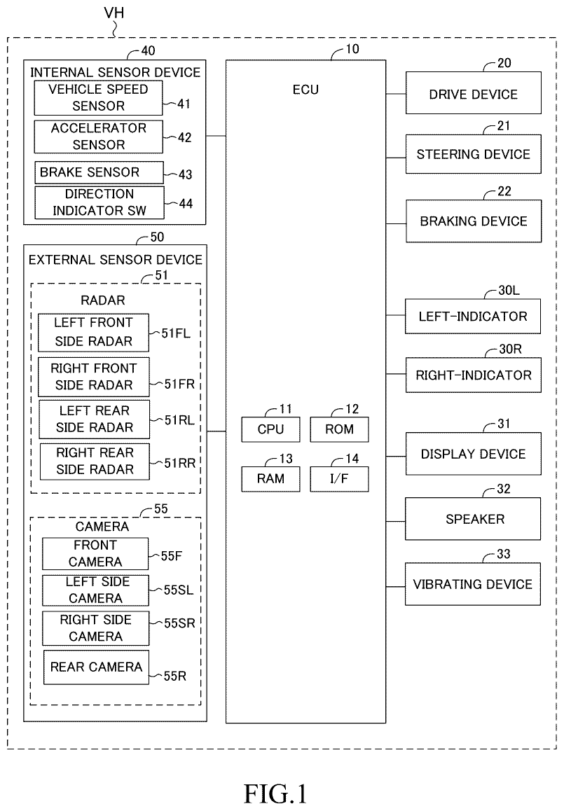

FIG. 1 is a schematic diagram of a hardware configuration of a vehicle SH according to the present embodiment. Hereinafter, the vehicle SH may be referred to as an own vehicle when it is required to distinguish it from other vehicles.

The vehicle VH has an ECU (Electronic Control Unit) 10. The ECU 10 includes a CPU (Central Processing Unit) 11, ROM (Read Only Memory) 12, RAM (Random Access Memory) 13, an interface device 14, and the like. The CPU 11 executes various programs stored in the ROM 12. The ROM 12 is a non-volatile memory that stores data and the like required for the CPU 11 to execute various programs. The RAM 13 is a volatile memory to provide a working region that is deployed when various programs are executed by the CPU 11. The interface device 14 is a communication device for communicating with an external device.

The ECU 10 is a central device which executes driving assistance control of the vehicle VH. Driving assistance control is a concept which encompasses automatic driving control. Therefore, a drive device 20, a steering device 21, a braking device 22, a left-indicator 30L, a right-indicator 30R, a display device 31, a speaker 32, a vibrating device 33, an internal sensor device 40, and an external sensor device 50, and the like are communicably connected to the ECU 10.

The drive device 20 generates a driving force to be transmitted to driving wheels of the vehicle VH. As the drive device 20, for example, an engine and a motor are given. In the device according to the at least one embodiment, the vehicle VH may be any one of a hybrid electric vehicle (HEV), a plug-in hybrid electric vehicle (PHEV), a fuel cell electric vehicle

(FCEV), a battery electric vehicle (BEV), and an engine vehicle.

The steering device 21 applies steering forces to steerable wheels of the vehicle VH. The braking device 22 applies a braking force to the wheels of the vehicle VH.

The left-indicator 30L and the right-indicator 30R are indicators for alerting drivers of the vehicle VH. The left-indicator 30L is configured, for example, by incorporating a LED (Light-Emitting Diode) into a part of the mirror of the left-side mirror. The right-indicator 30R is configured, for example, by incorporating the LED into a part of the mirror of the right-side mirror. The left-indicator 30L and the right-indicator 30R have the same configuration. Hereinafter, when the left-indicator 30L and the right-indicator 30R do not need to be distinguished from each other, they are also simply referred to as indicators 30. The indicators 30 are independently lit or flashed on the left and right sides by a lighting signal or a flashing signal transmitted from ECU 10. When the vehicle VH includes an electronic side mirror, the indicators 30 can be displayed as images on a monitor for an electronic side mirror provided in the vehicle interior.

The display device 31 is, for example, a multi-information display, and displays various images in accordance with a command from the ECU 10. The display device 31 May be a center display, a head-up display, or the like. The speaker 32 is, for example, a speaker of an audio system or a speaker of a navigation system, and outputs a warning sound or the like in response to a command from the ECU 10. The vibrating device 33 is provided, for example, on a steering wheel (not shown), and vibrates the steering wheel in response to a command from the ECU 10.

The internal sensor device 40 is sensors which acquire states of the vehicle VH. Specifically, the internal sensor device 40 includes a vehicle speed sensor 41, an accelerator sensor 42, a brake sensor 43, a direction indicator switch 44, and the like. The vehicle speed sensor 41 detects a travel speed (vehicle speed V) of the vehicle VH. The accelerator sensor 42 detects an operation amount of an accelerator pedal (not shown) by the driver. The brake sensor 43 detects an operation amount of a brake pedal (not shown) by the driver. The direction indicator switch 44 detects an operation direction (a left operation signal and a right operation signal) of an indicator lever (not shown) by the driver. The internal sensor device 40 transmits the condition of the vehicle VH detected by the sensors 41 to 44 to the ECU 10 at a predetermined cycle.

The external sensor device 50 is sensors which acquire a target information of the objects around the vehicle VH. Specifically, the external sensor device 50 includes a radar sensor 51, a camera 55, and the like. As the target information, there are given, for example, a peripheral vehicle, a, a pedestrian, and a bicycle, and the like. The external sensor device 50 transmits the acquired target information to the ECU 10 at a predetermined cycle.

The radar sensor 51 detects a target existing around the vehicle VH. The radar sensor 51 includes a millimeter wave radar or Lidar. The millimeter wave radar radiates a radio wave (millimeter wave) in a millimeter wave band, and receives the millimeter wave (reflected wave) reflected by a target existing within a radiation range. The millimeter wave radar acquires a relative distance between the vehicle VH and the target, a relative speed between the vehicle VH and the target, and the like based on a phase difference between the transmitted millimeter wave and the received reflected wave, an attenuation level of the reflected wave, a time from the transmission of the millimeter wave to the reception of the reflected wave, and the like. The Lidar sequentially scans laser light in a pulse form having a shorter wavelength than that of the millimeter wave in a plurality of directions, and receives reflected light reflected by a target, to thereby acquire a shape of the target detected in front of the vehicle VH, the relative distance between the vehicle VH and the target, the relative speed between the vehicle VH and the target, and the like.

In the present embodiment, the radar 51 includes a left front side radar 51FL, a right front side radar 51FR, a left rear side radar 51RL, and a right rear side radar 51RR. The detection regions of the radar 51FL, 51FR, 51RL, 51RR are wide-angle regions each having a predetermined angle in the left direction and the right direction around the radar axis. The radar axis of the left front side radar 51FL is directed obliquely to the left front of the vehicle VH. The radar axis of the right front side radar 51FR is directed obliquely to the right front of the vehicle VH. The radar axis of the left rear side radar 51RL is directed to the left obliquely rearward side of the vehicle VH. The radar axis of the right rear side radar 51RR is directed to the right obliquely rearward side of the vehicle VH. The detection region of the left rear side radar 51RL includes a blind spot region in which the driver is difficult to visually recognize by the left side mirror. The detection region of the right rear side radar 51RR includes a blind spot region in which the driver is difficult to visually recognize by the right side mirror.

The camera 55 is, for example, a stereo camera or a monocular camera, and a digital camera including an image pickup element such as a CMOS sensor or a CCD sensor can be used as the camera 55. The camera 55 captures a region around of the vehicle VH, and processes captured image data, to thereby obtain the target information around the vehicle VH. The target information is information indicating a type of the target detected around the vehicle VH, the relative distance between the vehicle VH and the target, the relative speed between the vehicle VH and the target, and the like. The type of the target may be recognized by machine learning such as pattern matching, for example.

In the present embodiment, the camera 55 includes a front camera 55F, a left side camera 55SL, a right side camera 55SR, and a rear camera 55R. The optical axis of the front camera 55F is directed forward of the vehicle VH. The optical axis of the left side camera 55SL is directed to the left side of the vehicle VH. The optical axis of the right side camera 55SR is directed to the right side of the vehicle VH. The optical axis of the rear camera 55F is directed to the rear of the vehicular VH. The cameras 55F, 55SL, 55SR, 55R are provided with wide angle lenses, and image a predetermined area on the left and right with respect to the optical axis. In other words, the camera 55 can acquire the target object information around the entire circumference of the vehicle VH.

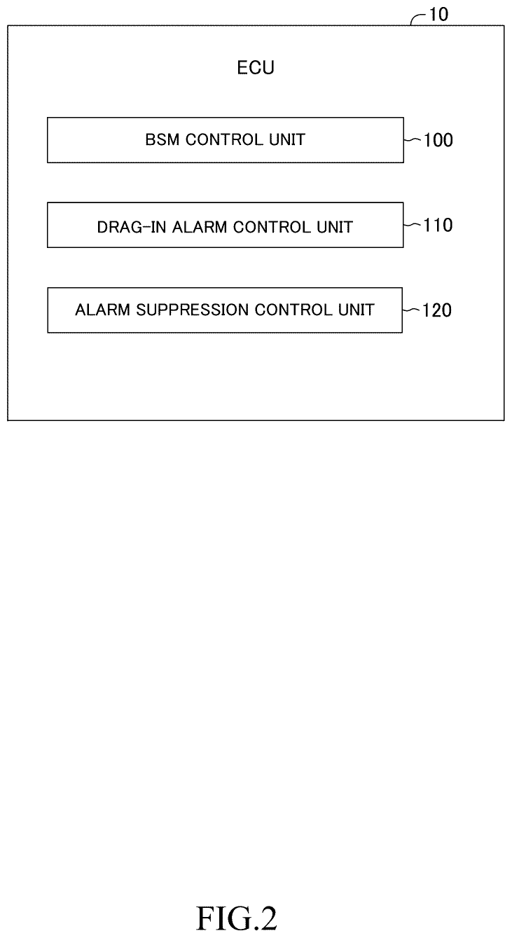

FIG. 2 is a schematic diagram showing a software configuration of the ECU 10 to the present embodiment. As shown in FIG. 2, the ECU 10 includes a BSM (Blind Spot Monitoring) control unit 100, a drag-in alarm control unit 110, an alarm suppression control unit 120, and the like as a part of functional elements. The functional elements 100 to 120 are realized by the CPU 11 of the ECU 10 reading a program stored in the ROM 12 into a the RAM 13 and executing the program. Note that all or a part of the functional elements 100 to 120 may be provided in an another ECU separate from the ECU 10 or in an information processing device of a facility (a control center or the like) capable of communicating with the vehicle VH.

The BSM control unit 100 executes the BSM control to notify the drivers that there is a moving object such as another vehicle that runs in parallel in the blind spot area of the vehicle VH while the vehicle is traveling, or that there is a moving object such as another vehicle that approaches the vehicle VH from the rear of the neighboring lane. In the ROM 12 of the ECU 10, the relative position of the left blind spot region and the relative position of the right blind spot region with respect to the vehicle VH are stored, respectively. The left blind spot area is an area where the driver of the vehicle VH is difficult to visually recognize the surrounding state in the left side mirror, and the right blind spot area is an area where the driver of the vehicle VH is difficult to visually recognize the surrounding situation in the right side mirror.

The BSM control unit 100 sets a moving object as an alert target, when the moving object is detected in the left blind spot area on the basis of the target object data transmitted from the left rear side radar 51RL while the vehicle VH is traveling. Similarly, the BSM control unit 100 sets the moving object as an alert target, when the moving object is detected in the right blind spot area on the basis of the target object data transmitted from the right rear side radar 51RR while the vehicle VH is traveling.

Further, when the BSM control unit 100 detects the moving object that is predicted to enter the left blind spot area from the left rear side of the vehicle VH within a predetermined period of time on the basis of the target object information transmitted from the left rear side radar 51RL while the vehicle VH is traveling, the moving object is set as an alert target. Similarly, when the BSM control unit 100 detects the moving object predicted to enter the right blind spot area from the right rear side of the vehicle VH within a predetermined period of time on the basis of the target object information transmitted from the right rear side radar 51RR while the vehicle VH is traveling, the moving object is set as an alert target.

The BSM control unit 100 turns on the left indicator 30L when the moving object on the left side of the vehicle VH is an alert target. Similarly, the BSM control unit 100 turns on the right indicator 30R when the moving object on the right side of the vehicle VH is set as an alert target. This makes it possible to notify the driver of the presence and direction of another vehicle or the like that is difficult to be visually recognized by the side mirror.

In addition, the BSM control unit 100 flashing the left indicator 30L when the left indicator 30L is turned on and a left operating signal is received from the direction indicator switch 44. Similarly, the BSM control unit 100 flashing the right indicator 30R when the right indicator 30R is turned on and a right operating signal is received from the direction indicator switch 44. As a result, the alarm level for urging the driver to give attention is increased. Hereinafter, an alarm for turning on the indicator 30 is referred to as a “first alarm”, and an alarm for flashing the indicator 30 is referred to as a “second alarm”. Note that the second alarm may be performed not only by flashing the indicator 30 but also by using at least one of a warning sound by the speaker 32, a warning display by the display device 31, and a warning vibration by the vibration device 33 in combination. By using any of these in combination, the alarm level of the second alarm can be further increased.

By the way, if an alarm process for detecting an object which is present in or is predicted to enter the blind spot area of the driver such as a BSM is applied to a drag-in alarm when the vehicle VH turns right and left at an intersection or the like, it is considered to be helpful in preventing the drag-in accidents. The drag-in alarm control unit 110 executes the drag-in alarm control for issuing an alarm when an object in which the vehicle VH is likely to be entrained is detected at an intersection or the like of the vehicle VH at right and left turning. Details of the drag-in alarm control will be described below.

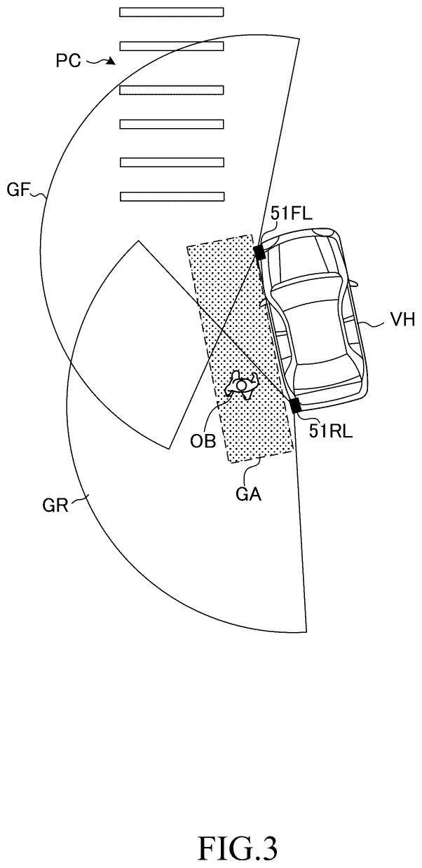

FIG. 3 is a schematic diagram for explaining the drag-in alarm control. In the following description, it is assumed that the driver's seat of the vehicle VH is provided on the right side, and the drag-in alarm control is executed when the vehicle VH turns left. Since the driver's seat of the vehicle VH is on the left side and the drag-in alarm control when the vehicle VH turns right is only reversed, detailed explanation will be omitted below.

In FIG. 3, the reference numeral denotes a detection area of the left front side radar 51FL, and reference numeral GR denotes a detection area of the left rear side radar 51RL. In addition, in FIG. 3, it is assumed that the vehicle VH will start to turn left at the intersection and is stopped in front of the crosswalk PC while flashing a left directional indicator (not shown). Note that the stop of the present disclosure includes not only a case where the vehicle VH is completely stopped but also a case where the vehicle VH is advancing at an ultra-low speed.

In FIG. 3, the reference numeral GA indicates a drag-in alarm area that is a region on the inner side of the turn of the vehicle VH. The drag-in alarm area GA is an example of “specified area” of the present disclosure, and is set as a substantially rectangular (band-shaped) area extending from front side of the vehicle VH to the rear side in a plan view of the vehicle VH when the vehicle VH turns left. The size and shape of the drag-in alarm area GA are not particularly limited, and may be set based on specific specifications such as the total length of the vehicle VH and the turning radius. The position of the drag-in alarm area GA relative to the vehicle VH is stored in advance in the ROM 12 of the ECU 10.

First, the drag-in alarm control unit 110 determines whether the vehicles VH is stopped and the first condition in which the left direction indicator is flashing is satisfied.

Whether or not the vehicle VH is stopped may be acquired based on the detection result of the vehicle speed sensor 41. Whether the left direction indicator is flashing may be acquired based on the detection result of the direction indicator switch 44.

When the first condition is satisfied, the drag-in alarm control unit 110 turns on the first condition flag F1 (F1=1).

When the first condition flag F1 is turned on, the drag-in alarm control unit 110 determines whether the second condition for detecting the moving objects OB at least partially entering the drag-in alarm area GA is satisfied based on the detection result of the left rear side radar 51RL (r the left side camera 55SL). When the second condition is satisfied, the drag-in alarm control unit 110 turns on the second condition flag F2 (F2=1).

When the first condition is satisfied (F1=1) and the second condition is satisfied (F2=1), the drag-in alarm control unit 110 executes the second alarm that causes the left indicator 30L to flash. At this time, the second alarm may be performed not only by flashing the left indicator 30L, but also by using at least one of a warning sound by the speaker 32, a warning display by the display device 31, and a warning vibration by the vibration device 33. Accordingly, it is possible to effectively notify the drivers that there is an object OB that is likely to be dragged by turning own vehicle VH to the left. That is, it is possible to prevent the drag-in accidents.

Here, even the moving object detected in the drag-in alarm area GA may be less likely to be actually dragged by the vehicle VH. Examples of the moving object include a pedestrian or a bicycle that approaches own vehicle VH to turn left from a direction opposite to the traveling direction of own vehicle VH. Such moving objects are visible by the drivers when they approach toward the own vehicle VH in the left front side area of the own vehicle VH. Further such moving objects continue moving away from the own vehicle VH after passing through the left front side area of the own vehicle VH. Therefore, even if the moving object enters the drag-in alarm area GA, the own vehicle VH is less likely to drag the moving object. When a second alarm having a higher alarm level than the first alarm is executed using a moving object having a low risk of entrainment as a target object, the driver is troublesome and confused. When the moving object is a moving object with a low risk of drag-in accidents, the alarm suppression control unit 120 executes alarm suppression control for lowering the alarm level. Details of the alarm suppression control will be described below.

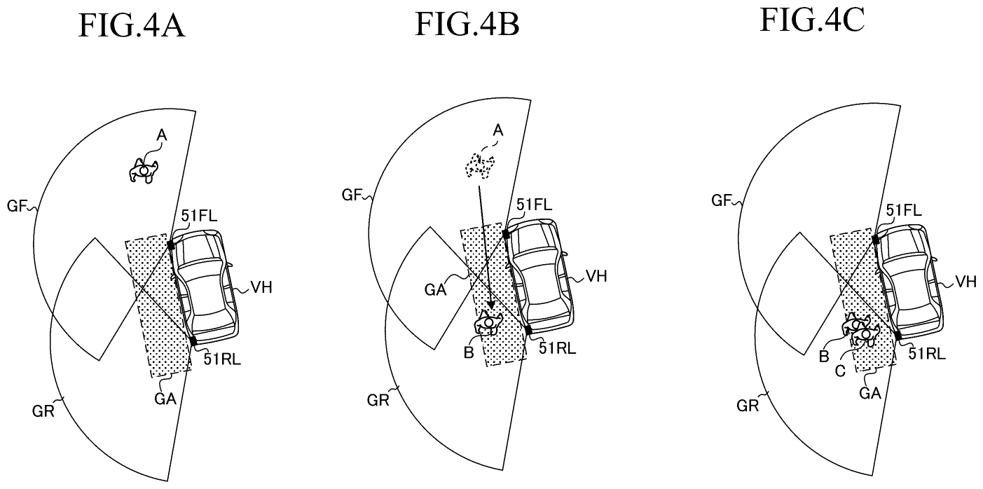

FIG. 4A illustrates a state where the first condition is satisfied (F1=1), that is, a state where the vehicle VH is stopped and the left indicator is flashing. When the first condition is satisfied, the alarm suppression control unit 120 detects, based on the detection result of the left front side radar 51FL, whether or not there is the moving object approaching the left front side area of the own vehicle VH from the opposite direction. When detecting the moving object approaching from the facing direction, the alarm suppression control unit 120 turns on the counter flag, and specifically recognizes the detected moving object as a target A. The target A is an example of an “approach target” of the present disclosure. When detecting a plurality of the moving objects, the alarm suppression control unit 120 turns on the counter flag for each of the plurality of the moving objects. That is, a plurality of moving objects are recognized as target A1, A2 . . . An (n is an integral number).

When the counter flag is turned on, the alarm suppression control unit 120 predicts whether the target A enters the drag-in alarm area GA after a lapse of a predetermined period (for example, several seconds) based on a feature of the target A.

Here, the feature of the target A includes a moving direction (vector), a moving speed (relative speed), a current position (relative position), a size (total length, total width), and the like. The feature of the target A is an example of the movement state amount of the present disclosure.

When predicting that the target A enters the drag-in alarm area GA after a predetermined period of time has elapsed, the alarm suppression control unit 120 predicts a future feature (vector, relative velocity, relative position, size, and the like) when the target A enters the detection area GR of the left rear side radar 51RL as the feature of the target B, as illustrated in FIG. 4B. The feature of the target B may be calculated based on the present feature of the target A, the mounting angle of the left rear side radar 51RL (the angle of the radar axis), and the like. The alarm suppression control unit 120 temporarily stores the predicted feature of the target object B in a storage device such as the RAM 13. The feature of the target B is an example of the predicted movement state amount of the present disclosure.

When the feature of the target B is stored, the alarm suppression control unit 120 determines whether the second condition is satisfied. That is, it is determined whether the moving object is detected in the drag-in alarm area GA. As illustrated in FIG. 4C, when the moving object is detected in the drag-in alarm area GA, the alarm suppression control unit 120 recognizes the detected moving object as the target C, and acquires the feature (vector, relative velocity, relative position, size, and the like) of the recognized target C based on the detection result of the external sensor device 50. The feature of the target C is an example of the actual movement state amount of the present disclosure.

The alarm suppression control unit 120 compares the feature of the target B with the feature of the target C. When the difference between the feature of the target B and the feature of the target C is equal to or larger than a predetermined amount, the target C actually detected in the drag-in alarm area GA is a target that differs from the target A. In other words, the target C can be said to be the moving object with a higher risk of drag-in of the own vehicle VH. In this case, the alarm suppression control unit 120 does not perform the suppression of the alarm level. That is, the drag-in alarm control unit 110 executes the second alarm as a normal alarm. As a result, the driver of own vehicle VH can be urged to pay attention, and the drag-in accidents can be prevented.

On the other hand, when the difference between the feature of the target B and the feature of the target C is less than the predetermined amount, that is, when the feature coincide with each other or substantially coincide with each other, the target C actually detected in the drag-in alarm GA can be regarded as the target A having a lower risk of drag-in of the own vehicle VH. In this case, the alarm suppression control unit 120 executes alarm suppression control for lowering the alarm level by the drag-in alarm control unit 110 from the second alarm to the first alarm. As a result, the execution of an unnecessary alarm for a moving object with a low risk of drag-in accidents is suppressed. That is, it is possible to effectively prevent the driver from being troubled.

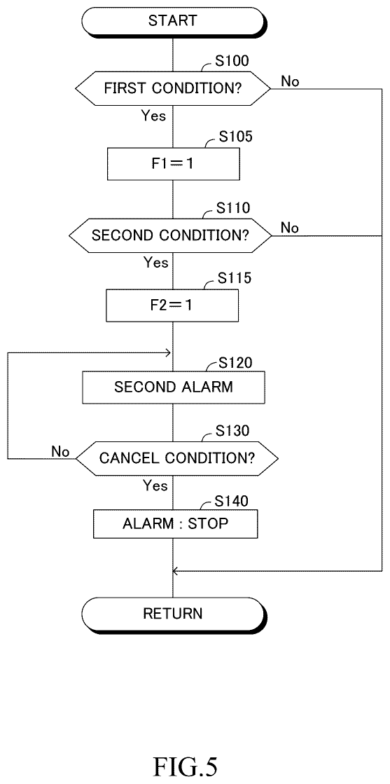

FIG. 5 is a flowchart for explaining a routine of the drag-in alarm control process by the CPU 11 of the ECU 10.

In step S100, the ECU 10 determines whether the first condition is satisfied in which the vehicles VH is stopped and the left indicator is flashing. When the first condition is satisfied (Yes), the ECU 10 advances the process to step S105, turns on the first condition flag (F1=1), and advances the process to step S110. On the other hand, if the first condition is not satisfied (No), the ECU 10 returns this routine.

In step S110, the ECU 10 determines whether the second condition for detecting the moving object at least partially entering the drag-in alarm area GA is satisfied based on the detection result of the left rear side radar 51RL. When the second condition is satisfied (Yes), the ECU 10 advances the process to step S115, turns on the second condition flag (F2=1), and advances the process to step S120. On the other hand, if the second condition is not satisfied (No), the ECU 10 returns this routine.

In step S120, the ECU 10 executes the second alarm that causes the left indicator 30L to be flashed. At this time, the second alarm may be performed not only by flashing the left-indicator 30L, but also by using at least one of a warning sound by the speaker 32, a warning display by the display device 31, and a warning vibration by the vibration device 33.

In step S130, the ECU 10 determines whether a predetermined alarm cancel condition is satisfied. Examples of the alarm cancel condition include a case where the moving object is not detected in the drag-in alarm area GA, a case where the direction indicator lever is operated in a neutral position or a clockwise direction, and the like. If the alarm cancel condition is not satisfied (No), the ECU 10 returns to the process of step S120 and continues the second alarm. On the other hand, if the alarm cancel condition is satisfied (Yes), the ECU 10 advances the process to step S140, stop the second alarm, and returns this routine.

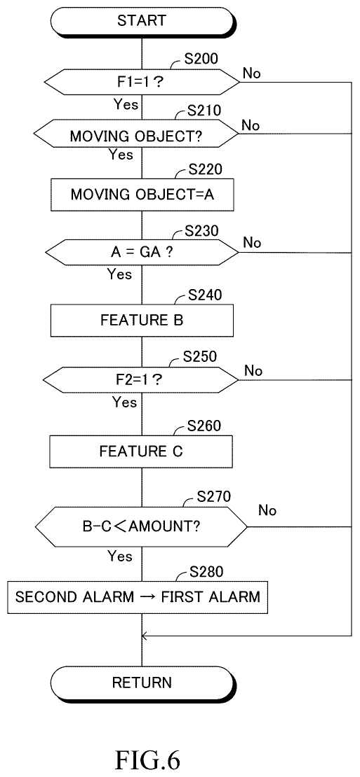

Next, based on the flow chart shown in FIG. 6, the alert suppression control routine executed by the CPU 11 of the ECU 10 will be described. This routine is executed in parallel with the routine of the drag-in alarm control shown in FIG. 5.

In step S200, the ECU 10 determines whether the first conditional flag is turned on (F1=1). If the first conditional flag is turned on (Yes), i.e., the vehicle VH is stopped and the left indicator is flashing, the ECU 10 advances the process to step S210. On the other hand, if the first conditional flag is not turned on (No), the ECU 10 returns this routine.

In step S210, the ECU 10 detects whether there is the moving object approaching own vehicle VH from the opposite direction, based on the detection result of the left front side radar 51FL. When the moving object approaching from the opposite direction is detected (Yes), the ECU 10 advances the process to step S220. On the other hand, if the moving object is not detected (No), the ECU 10 returns this routine.

In step S220, the ECU 10 turns on the counter flag, that is, recognizes the detected moving object as the target A. Next, in step S230, the ECU10 predicts whether the target A enters the drag-in alarm area GA after a predetermined period of time, based on the feature of the target A. If the target A is predicted to enter the drag-in alarm area GA (Yes), the ECU 10 advances the process to step S240. On the other hand, if the target A is not expected to enter the drag-in alarm area GA (No), the ECU 10 returns this routine.

In step S240, the ECU 10 predict the future feature when the target A enters the detection area GR of the left rear side radar 51RL as the feature of the target B, and temporarily store the feature of the target B in the storage device such as the

RAM 13. Next, in step S250, the ECU 10 determines whether the second condition flag is turned on (F2=1). If the second condition flag is turned on (Yes), that is, if the moving object is detected in the drag-in alarm area GA, the ECU 10 advances the process to step S260. On the other hand, if the second condition flag is not turned on (No), the ECU 10 returns this this routine.

In step S260, the ECU 10 recognizes the moving object detected in the drag-in alarm area GA as the target C, and acquires the feature of the target C. Next, in step S270, the ECU 10 compare the feature of the target B and the feature of the target C, and determine whether or not the difference between the feature of the target B and the feature of the target C is less than the predetermined amount. When the difference between the feature of the target B and the feature of the target C is equal to or larger than the predetermined amount (No), the ECU 10 returns this routine. That is, the second alarm based on the routine shown in FIG. 5 is executed. On the other hand, when the difference between the feature of the target B and the feature of the target C is less than the predetermined amount (Yes), the ECU 10 advances the process to step S280 to execute the alarm suppression control for lowering the alarm level from the second alarm to the first alarm, and then returns this this routine.

In the above, the driving assistance device and the driving assistance method according to the at least one embodiment have been described, but the present disclosure is not limited to the above-mentioned at least one embodiment, and various modifications are possible within the range not departing from the object of the present disclosure.

For example, in the above described embodiment, the ECU 10 has been described as suppressing the alarm from the second alarm to the first alarm when the difference between the feature of the target B and the feature of the target C is less than the predetermined amount, but may be configured to prohibit the alarm when the difference between the feature of the target B and the feature of the target C is less than the predetermined amount.

Further, in the above described embodiment, the ECU 10 executes the drag-in alarm control and the alarm suppression control when the own vehicle VH turns left and right at the intersection, but it can also be executed when own vehicle VH turns left and right at a location other than the intersection, such as when own vehicle VH turns right and left in the parking.

Further, in the above described embodiment, the ECU 10 detects the right or left turning intention of the driver based on the flashing of the direction indicator as the first condition for executing the drag-in alarm control, but may detect the right or left turning intention of the driver based on an operation other than the direction indicator. In this case, the right or left turning intention of the driver may be determined based on, for example, the steering operation amount, the brake operation amount, the line of sight direction acquired by a driver camera, or the like.

What is claimed is:

1. A driving assistance device for executing an alarm to a driver of a vehicle when a target object is present in a specific region including at least a region on a rear side of the vehicle on a side where the right or left side of the turn of the vehicle when the vehicle turning right or left, the driving assistance device comprising: a processor,
wherein the processor is configured to execute
predicting whether an approaching target enters the specific region after a predetermined time has elapsed on the basis of a moving state amount including at least a moving direction and a moving speed of the approaching target, when detecting the intention of the right or left turning of the driver and when detecting the approaching target in a region on a front side of the vehicle on a side where the right or left side of the turn of the vehicle;
predicting, when predicting that the approaching target enters the specific region, a moving state amount as a predicted moving state amount when the approaching target enters the specific region;
acquiring an actual movement state amount of an entry target as an actual movement state amount, when detecting the entry target that has entered the specific region; and
determining whether or not the alarm for the entry target as an object target is necessary on the basis of the predicted moving state amount and the actual moving state amount.

2. The driving assistance device according to claim 1,
wherein the processor is configured to suppressing the alarm when a difference between the predicted moving state amount and the actual moving state amount is less than a predetermined amount.

3. The driving assistance device according to claim 2,
wherein the processor is configured to:
having a first alarm and a second alarm that is higher alarm level than the first alarm;
executing the second alarm when a difference between the predicted moving state amount and the actual movement state amount is equal to or larger than the predetermined amount; and
executing the first alarm when the difference between the predicted moving state amount and the actual moving state amount is less than the predetermined amount.

4. The driving assistance device according to claim 3,
wherein the processor is configured to:
turning on an indicator on the side of the turn of the vehicle as the first alarm, the indicator is provided on the left and right side mirrors of the vehicle; and
flashing the indicator on the side of the turn of the vehicle as the second alarm.

5. A driving assistance method for executing an alarm to a driver of a vehicle when a target object is present in a specific region including at least a region on a rear side of the vehicle on a side where the right or left side of the turn of the vehicle when the vehicle turning right or left, the driving assistance method comprising:
predicting whether an approaching target enters the specific region after a predetermined time has elapsed on the basis of a moving state amount including at least a moving direction and a moving speed of the approaching target, when detecting the intention of the right or left turning of the driver and when detecting the approaching target in a region on a front side of the vehicle on a side where the right or left side of the turn of the vehicle;
predicting, when predicting that the approaching target enters the specific region, a moving state amount as a predicted moving state amount when the approaching target enters the specific region;
acquiring an actual movement state amount of an entry target as an actual movement state amount, when detecting the entry target that has entered the specific region; and
determining whether or not the alarm for the entry target as an object target is necessary on the basis of the predicted moving state amount and the actual moving state amount.
